(19) United States
(12) Patent Application Publication
(10) Pub. No.: US 2021/0329988 A1
(43) Pub. Date: Oct. 28, 2021

(54) MASK IMPROVEMENT

(71) Applicant: Gerard Arrotti, Unionville, CT (US)

(72) Inventor: Gerard Arrotti, Unionville, CT (US)

(21) Appl. No.: 16/874,671

(22) Filed: May 14, 2020

Related U.S. Application Data
(60) Provisional application No. 63/016,080, filed on Apr. 27, 2020.

(51) Int. Cl. A41D 13/11; A62B 9/00; B01D 53/26

(52) U.S. Cl. CPC A41D 13/11; A41D 31/145; B01D 53/261; A62B 9/003

(57) ABSTRACT

According to some embodiments, a protective face mask to protect medical personnel by filtering exhaled air of infectious patients is disclosed. The protective face mask comprises a first layer, a second layer and a third layer. The second layer comprises a molecular sieve desiccant. The molecular sieve desiccant is between 0.1 cm and 10 cm thick.

### BACKGROUND

Surgical masks are designed to protect medical personnel by filtering exhaled air of infectious patients. N95 respirators are designed to protect the person wearing the respirator by filtering about 95% of 1-micron size airborne particles. The N95 mask utilizes a fine mesh of filtration media for filtering hazardous particles. Many N95 respirators are equipped with exhalation valves that do not filter the wearers ‘exhaled air. Thus, if the person wearing the N95 respirator (equipped with an exhalation) is infected with SARS-COV-2 or another human airborne pathogen; they can still transmit the pathogen via the exhalation valve.

Human exhaled air contains a great deal of moisture and viruses attach to these droplets and this is the primary mode of transmission of pathogens such as SARS-COV-2. These droplets also settle out of the air after exhalation, landing on surfaces and contaminating those surfaces. Surface contamination is a secondary mode of transmission. However, N95 masks make it tough for a wearer, especially one with compromised lungs, to effectively breathe. Therefore, a mask that allows for easy breathing and can prevent airborne pathogens from escaping is desirable.

### SUMMARY

Some embodiments described herein relate to a protective face mask to protect medical personnel by filtering exhaled air of infectious patients is disclosed. The protective face mask comprises a first layer, a second layer and a third layer. The second layer comprises a molecular sieve desiccant.

### BRIEF DESCRIPTION OF THE DRAWING

FIG. 1 illustrates a face mask in accordance with some embodiments.

FIG. 2 illustrates a face mask in accordance with some embodiments.

FIG. 3 illustrates a portion of a face mask in accordance with some embodiments.

FIG. 4 illustrates a face mask in accordance with some embodiments.

FIG. 5 illustrates a face mask cartridge in accordance with some embodiments.

### DETAILED DESCRIPTION

In the following detailed description, numerous specific details are set forth in order to provide a thorough understanding of the embodiments. However, it will be understood by those of ordinary skill in the art that the embodiments may be practiced without these specific details. In other instances, well-known methods, procedures, and components have not been described in detail so as not to obscure the embodiments.

The present embodiments described herein relate to an improvement to face masks such as, but not limited to, home-made face masks comprised of cloth and/or paper fabric, respirators and face coverings. Fabric Masks are highly porous and do not stop, or trap, human airborne pathogens that are exhaled. By inserting a pouch that includes a molecular sieve desiccant between two layers of fabric or cloth, the efficiency of stopping airborne pathogens in dramatically increased and a molecular sieve desiccant allows for greater airflow than N95 which may make breathing more conformable for a wearer.

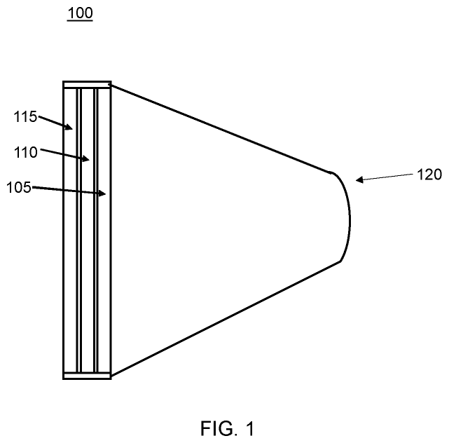

Referring now to FIG. 1, an embodiment of a protective face mask 100 is illustrated. The protective face mask 100 comprises a first layer 105, a second layer 110 and a third layer 115. The protective face mask 100 is affixed to a wearer's head via a strap 120. The first layer 105 and the third layer 115 may be comprised of cloth such as, but not limited to, a cotton and polyester blend fabric. In some embodiments, he first layer 105 and the third layer 115 may be comprised of paper, a heat resistant plastic, an elastomer, a polymer or a combination thereof.

The second layer 110 may be comprised of a molecular sieve desiccant. In some embodiments, the molecular sieve desiccant may include 13× molecular sieve which is a highly porous, high capacity alkali metal alumino-silicate in a spherical form. The pores of 13× molecular sieve are 10 angstrom and are selective for polar molecules like water. Since a human exhale is primarily made of moisture, 13× molecular sieve may be incorporated into a protective mask to absorb the moisture and thus absorb any airborne pathogens contained within the moisture. In some embodiments, the second layer 110 may comprise a removable pouch that contains the molecular sieve desiccant. In this embodiment, the pouch may be removed and then heated to kill any pathogens. For example, heating the molecular sieve desiccant to a temperature of between 300 degrees Fahrenheit and 400 degrees Fahrenheit may kill any pathogens within the molecular sieve desiccant. In some embodiments, the entire mask may be capable of withstanding heats of 300 degrees Fahrenheit to 400 degrees Fahrenheit and, in this embodiment, the entire protective mask may be heated to 300-400 degrees Fahrenheit to sterilize the entire protective mask.

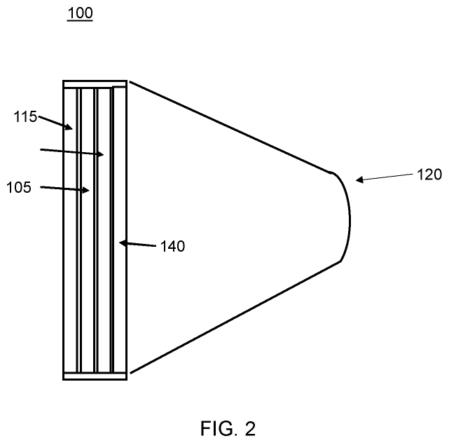

In some embodiments, a 13× molecular sieve particle size of 8×12 may be used in a 6.5 cm by 5.5 cm porous pouch that is packed to a thickness of approximately 1 cm. However, in some embodiments, wherein the molecular sieve desiccant comprises a 13× molecular sieve desiccant, a thickness between 0.1 cm and 10 cm thick may be used. In some embodiments, two pouches of a molecular sieve desiccant may be used and placed between 2 outer layers (e.g., layer 110 and layer 115) of fabric mask and 1 inner layer 140 as illustrated in FIG. 2. The packets may be positioned roughly in the middle of the mask by the nose and mouth.

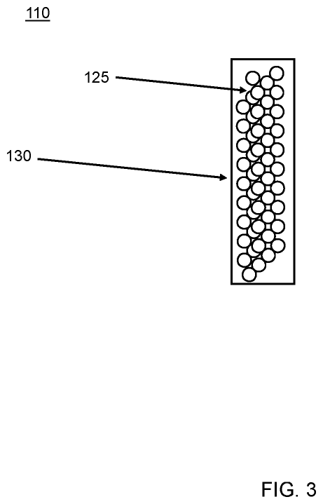

Referring now to FIG. 3, an embodiment of the second layer 110 is illustrated. In this embodiment, the second layer 110 comprises a molecular sieve desiccant pouch which is includes an outer shell that is comprised of a heat resistant cloth, plastic or polymer 130. The outer shell is a breathable material (e.g., is has the ability to allow moisture vapor to be transmitted through the material) and is filled with spherical molecular sieve desiccant particles 125 that absorb moisture. Because particles absorb moisture, pathogens contained in moisture/breath are absorbed into an interior of each particle and do not lie on a surface or skin of each particle. As such, pathogens are contained within each particle. In some embodiments, a fabric mask alone versus mask using 13× molecular sieve showed improvements in capturing exhaled aerosols 10 microns in size by approximately 60 percent. Home-made fabric masks in combination with 13× molecular sieve pouches can markedly improve efficiency of capturing water laden exhaled air and not increase breathing resistance.

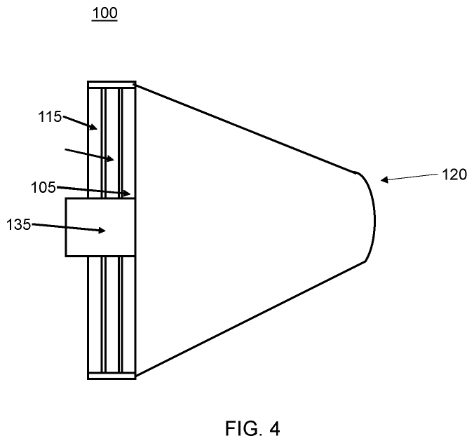

Referring now to FIG. 4, to improve breathing, a one-way inhalation valve 135 may be added to a protective mask 100. The one-way inhalation valve 135 may function as a check valves for uni-directional air flow. This may permit fresh air to enter the mask while preventing contaminated air from leaving the mask.

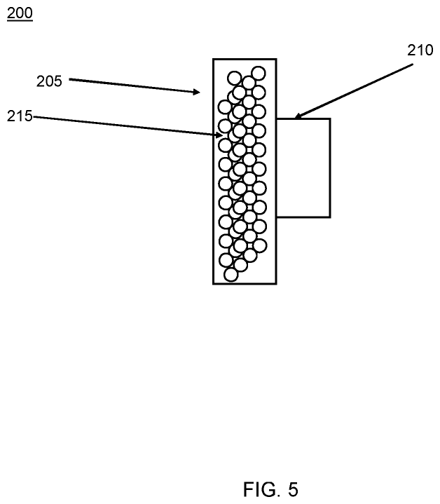

Referring now to FIG. 5, an embodiment of a respirator face mask cartridge 200 is illustrated. The respirator face mask cartridge 200 comprises a molecular sieve desiccant 215 and a casing 205 to hold the molecular sieve desiccant. The respirator face mask cartridge 200 further comprises a connector 210 to create an airtight seal with a face mask. The molecular sieve desiccant 215 may comprise a 13× molecular sieve desiccant and the respirator face mask cartridge 200 may holds between 60 grams and 150 grams of the molecular sieve desiccant. In some embodiments, the casing comprises a thermoplastic material that may be heated to between 300 degrees Fahrenheit and 400 degrees Fahrenheit to kill off any pathogens contained within the molecular sieve desiccant 215. In this regard, the respirator face mask cartridge 200 may be reusable.

This written description uses examples to disclose multiple embodiments, including the preferred embodiments, and also to enable any person skilled in the art to practice the invention, including making and using any devices or systems and performing any incorporated methods. Aspects from the various embodiments described, as well as other known equivalents for each such aspects, can be mixed and matched by one of ordinary skill in the art to construct additional embodiments and techniques in accordance with principles of this application.

Those in the art will appreciate that various adaptations and modifications of the above-described embodiments can be configured without departing from the scope and spirit of the claims. Therefore, it is to be understood that the claims may be practiced other than as specifically described herein.

What is claimed:

1. A protective face mask, comprising:
a first layer;
a second layer comprised of a molecular sieve desiccant; and
a third layer.

2. The protective face mask of claim 1, wherein the molecular sieve desiccant comprises a 13× molecular sieve desiccant.

3. The protective face mask of claim 1, wherein the molecular sieve desiccant comprises a 13× molecular sieve desiccant between 0.1 cm and 10 cm thick.

4. The protective face mask of claim 1, wherein the second layer is disposed between the first layer and the third layer.

5. The protective face mask of claim 1, wherein the first layer, and the second layer are can withstand heats between 300 degrees Fahrenheit 400 degrees Fahrenheit.

6. The protective face mask of claim 1, wherein the first layer and the third layer comprise at least one of cloth, plastic and an elastomer.

7. The protective face mask of claim 1, wherein the first layer and the third layer comprise paper.

8. The protective face mask of claim 1, wherein the second layer comprises a desiccant pouch to hold the molecular sieve desiccant and can withstand temperatures between 300 degrees Fahrenheit 400 degrees Fahrenheit.

9. The protective face mask of claim 1, further comprising a fourth layer wherein the fourth layer is disposed between a user's face and the first layer and wherein the second layer is disposed between the first layer and the third layer.

10. A respirator face mask cartridge, comprising:
a molecular sieve desiccant; and
a casing to hold the molecular sieve desiccant.

11. The respirator face mask cartridge of claim 10, wherein the molecular sieve desiccant comprises a 13× molecular sieve desiccant.

12. The respirator face mask cartridge of claim 10, wherein the molecular sieve desiccant is between 0.1 cm and 10 cm thick.

13. The respirator face mask cartridge of claim 10, wherein the cartridge holds between 60 grams and 150 grams of the molecular sieve desiccant.

14. The respirator face mask cartridge of claim 11, wherein the casing comprises a thermoplastic material.

15. A protective face mask, comprising:
a first layer;
a second layer comprised of a molecular sieve desiccant; and
a third layer wherein the second layer is disposed between the first layer and the third layer; and
a one-way inhalation valve.

16. The protective face mask of claim 15, wherein the molecular sieve desiccant comprises a 13× molecular sieve desiccant between 0.1 cm and 10 cm thick.

17. The protective face mask of claim 15, wherein the second layer comprises a pouch to hold the molecular sieve desiccant.

18. The protective face mask of claim 15, wherein molecular sieve desiccant is a high heat desiccant and is regenerated by dry heating.

19. The protective face mask of claim 15, wherein the first layer and the third layer comprise at least one of cloth, plastic and an elastomer.

20. The protective face mask of claim 15, further comprising a fourth layer wherein the fourth layer is disposed between a user's face and the first layer and wherein the second layer is disposed between the first layer and the third layer.
